(19) United States
(12) Patent Application Publication
(10) Pub. No.: US 2020/0363220 A1
(43) Pub. Date: Nov. 19, 2020

(54) SYSTEMS AND METHODS FOR PERSONALIZED GROUND TRANSPORTATION

(71) Applicant: Evangelos Simoudis, Menlo Park, CA (US)

(72) Inventor: Evangelos Simoudis, Menlo Park, CA (US)

(21) Appl. No.: 16/983,485

(22) Filed: Aug. 3, 2020

Related U.S. Application Data
(63) Continuation of application No. PCT/US19/56352, filed on Oct. 15, 2019.
(60) Provisional application No. 62/845,046, filed on May 8, 2019.
(60) Provisional application No. 62/803,749, filed on Feb. 11, 2019.
(60) Provisional application No. 62/746,419, filed on Oct. 16, 2018.

(51) Int. Cl. G01C 21/34; G06Q 30/02; G06Q 10/10; G06Q 50/30; G06N 20/00; G06N 5/04; G01C 21/36

(52) U.S. Cl. CPC G01C 21/3423; G06Q 30/0205; G06Q 10/1093; G06Q 50/30; G06Q 30/0266; G06Q 10/02; G06Q 30/0269; G06N 20/00; G06N 5/04; G01C 21/3617; G01C 21/3484; G06Q 30/0255

(57) ABSTRACT

The present disclosure provides methods and systems for facilitating commerce while a user is traveling along a travel route. A method for facilitating commerce while a user is traveling along a travel route may comprise: (a) at a server, receiving a starting geographic location and a destination geographic location of the user; (b) using the starting geographic location and the destination geographic location to generate the travel route for the user, which travel route is directed from the starting geographic location to the destination geographic location; (c) using the server to identify one or more transactional options for the user along the route; and (d) while the user is traveling in a terrestrial vehicle along at least a portion of the travel route, presenting the one or more transactional options to the user on an electronic device.

### CROSS-REFERENCE

This application is a continuation application of International Patent Application PCT/US2019/056352, filed Oct. 15, 2019, which claims priority to U.S. Provisional Application No. 62/746,419, filed Oct. 16, 2018, U.S. Provisional Application No. 62/803,749, filed Feb. 11, 2019, and U.S. Provisional Application No. 62/845,046, filed May 8, 2019, each of which is incorporated herein by reference in its entirety.

### BACKGROUND

The rapid expansion in the computing capability of mobile computing devices, such as smartphones, tablet computers and other portable devices, and the growth in the number and advancement of software program applications (or “apps”) for mobile devices, has greatly increased the dependence of individuals on devices, apps and related platforms in the field of personal productivity. For example, apps are widely used for scheduling meetings, determining travel routes, selecting transit modes, and other functions.

The emergence, and acceptance, of mobility services such as consumer adoption of peer-to-peer car sharing and ride-hailing services (e.g., Uber® and Lyft®) has encouraged a combination of transportation and mobile applications. Next-generation mobility is about autonomous and automated vehicles, electrified vehicles, and on-demand shared mobility and the use cases they enable. Autonomous vehicles that are capable of operation without human intervention are rapidly improving. As such vehicles are commercialized, they may improve local transportation by providing greater functionality and allowing new methods and systems to be utilized for moving passengers and cargo. One such enabling-functionality is the ability of the vehicle to move from one location to another location in an autonomous manner. Challenges may arise as to how to best utilize available transportation and logistics resources, in conjunction with various types of autonomous vehicles.

### SUMMARY

Recognized herein is a need for methods and systems for providing products or services for use with vehicles, such as fully autonomous, pilotless vehicles. Beneficially, such products or services may facilitate savings in both time and resources for users of the vehicles. Additionally, it can allow companies offering those products or services to more directly engage with end consumers in a vehicular transportation environment.

The present disclosure provides systems and methods for generating a personalized transportation experience with customized passenger commerce services. In particular, the personalized transportation experience can involve transportation via autonomous vehicles that do not require a fleet operator. The personalized transportation experience can be provided with any transportation mode, such as, for example, autonomous vehicle, ride-hailing service, fleet-based services, microtransit (e.g., fleet-based demand responsive transit), rail transportation, and/or terrestrial mass transit vehicle. A personalized transportation plan may be generated using a machine learning system with minimal human intervention. The provided systems and methods may allow for a range of new use cases for pilotless/driverless vehicles in industries such as hotels and hospitality, restaurants and dining, tourism and entertainment, healthcare, service delivery, and the like.

In an aspect, a method for facilitating commerce while a user is traveling along a travel route is provided. The method may comprise: (a) at a server, receiving a starting geographic location and a destination geographic location of the user; (b) using the starting geographic location and the destination geographic location to generate the travel route for the user, which travel route is directed from the starting geographic location to the destination geographic location; (c) using the server to identify one or more transactional options for the user along the route; and (d) while the user is traveling in a terrestrial vehicle along at least a portion of the travel route, presenting the one or more transactional options to the user on an electronic device.

In another aspect, a method for facilitating commerce while a user is traveling along a travel route may comprise: (a) at a server, receiving a starting geographic location and a destination geographic location of the user; (b) using the starting geographic location and the destination geographic location to generate the travel route for the user, which travel route is directed from the starting geographic location to the destination geographic location; (c) using the server to identify one or more transactional options for the user along the route; and (d) presenting the one or more transactional options on an electronic device while the user is travelling along a segment of the travel route in a terrestrial mass transit vehicle, and the one or more transactional options are determined based at least in part on one or more members selected from the group consisting of a social graph of the user, a transportation graph of the user, a visitation graph of the user, a purchase graph of the user, calendar data and to-do list data.

In some embodiments, the destination geographic location is automatically determined based on historical data related to the user. In some embodiments, the starting geographic location is determined using a geographic location of the electronic device, which geographic location is determined by a global position system or signal triangulation. In some embodiments, the starting geographic location is entered by the user via a graphical user interface (GUI) on the electronic device. In some embodiments, the travel route and the one or more transactional options are generated using a machine learning algorithm. In some embodiments, the one or more transactional options are determined based at least in part on one or more members selected from the group consisting of a social graph of the user, a transportation graph of the user, a visitation graph of the user, a purchase graph of the user, calendar data and to-do list data. In some embodiments, the method further comprises determining a transportation mode for one or more portions of the travel route. In some cases, the transportation mode comprises autonomous personally owned vehicle, ride-hailing service or ride sharing service delivered using autonomous or human driven vehicle, rail transportation, and/or terrestrial mass transit vehicle. In some cases, a transportation mode determined for a first portion is different from a transportation mode determined from a second portion. In some embodiments, the method further comprises receiving a user input indicating acceptance of at least one of the one or more transaction options and in response to receiving the user input, conducting the at least one transaction option. In some embodiments, the method further comprises generating a new transaction option upon receiving a user input indicating a rejection of one of the one or more transaction options.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

In another aspect, a method for facilitating commerce while a user is traveling along a route is provided. The method comprises: (a) at a server, receiving a starting geographic location and a destination geographic location of the user; (b) using the starting geographic location and the destination geographic location to generate the route for the user, which route is directed from the starting geographic location to the destination geographic location; (c) using the server to identify one or more transactional options for the user along the route; and (d) presenting the one or more transactional options on an electronic device of the user while the user is travelling along a segment of the route in a terrestrial vehicle, wherein the one or more transactional options are determined based at least in part on one or more members selected from the group consisting of a social graph of the user, a transportation graph of the user, a visitation graph of the user, a purchase graph of the user, calendar data and to-do list data.

In some embodiments, the destination geographic location is automatically determined based on historical data related to the user. In some embodiments, the starting geographic location is entered by the user via a graphical user interface (GUI) on the electronic device. In some embodiments, the route and the one or more transactional options are generated using a machine learning algorithm.

In some embodiments, the method further comprises determining a transportation mode for one or more segments of the route. In some cases, the transportation mode comprises autonomous vehicle, ride-hailing service, rail transportation, and/or terrestrial mass transit vehicle. In some instances, the transportation mode comprises a type of autonomous vehicle. In some embodiments, at least one of the one or more transaction options is to be conducted at a location connecting two consecutive segments of the route.

In another aspect, a method is provided for facilitating commerce while a user is traveling along a travel route. The method comprises: (a) at a server, receiving a starting geographic location and a destination geographic location of the user; (b) using the starting geographic location and the destination geographic location to generate the travel route for the user, which travel route is directed from the starting geographic location to the destination geographic location; (c) using the server to identify one or more transactional options for the user along the travel route; and (d) presenting the one or more transactional options on an electronic device of the user while the user is travelling along a segment of the travel route in an (1) autonomous vehicle or (2) a terrestrial mass transit vehicle.

In some embodiments, the destination geographic location is automatically determined based on historical data related to the user. In some embodiments, the starting geographic location is entered by the user via a graphical user interface (GUI) on the electronic device. In some embodiments, the travel route and the one or more transactional options are generated using a machine learning algorithm. In some embodiments, the one or more transactional options are determined based at least in part on one or more members selected from the group consisting of a social graph of the user, a transportation graph of the user, a visitation graph of the user, a purchase graph of the user, calendar data and to-do-list data.

In some embodiments, the method further comprises determining a transportation mode for one or more segments of the travel route. In some cases, the transportation mode comprises autonomous vehicle, ride-hailing service, rail transportation, and/or terrestrial mass transit vehicle. In some instances, the transportation mode comprises a type of autonomous vehicle. In some embodiments, at least one of the one or more transaction options is to be conducted at a location connecting two consecutive segments of the travel route. In some embodiments, the method further comprises repeating (b) and/or (c) upon detection of a change in the calendar data or to-do-list data associated with the user.

In another aspect, a method is provided for facilitating commerce while a user is traveling along a route. The method comprises: (a) at a server, receiving a starting geographic location and a destination geographic location of the user; (b) using the starting geographic location and the destination geographic location to generate the route for the user, which route is directed from the starting geographic location to the destination geographic location; (c) using the sever to extract contextual information associated with the destination geographic location; and (d) using the server to identify one or more transactional options for the user along the route based at least in part on the contextual information.

In some embodiments, the method further comprises, while the user is traveling in a terrestrial vehicle along at least a portion of the route, presenting the one or more transactional options to the user on an electronic device within the terrestrial vehicle. In some cases, the terrestrial is an autonomous vehicle. In some embodiments, the contextual information comprises an activity associated with the destination geographic location. In some embodiments, the one or more transactional options are determined based at least in part on a segment to which the user is assigned.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which various principles of the disclosure are utilized, and the accompanying drawings (also “Figure” and “FIG.” herein), of which:

FIG. 1 schematically shows an example of a network environment in which a personal transportation management system may be operated.

FIG. 2 shows examples of user database, in accordance with some embodiments.

FIG. 3 shows an example of a transportation graph.

FIG. 4 shows an example of a personalized transportation plan.

FIG. 5 shows an example of another personalized transportation plan.

FIG. 6 shows an example process of generating one or more transactional options for a user during a daily transportation.

FIG. 7 shows an example process of providing personalized passenger commerce during transportation.

FIG. 8 schematically shows a transport plan engine in communication with a plurality of databases and sources of data for generating a personalized transportation experience.

FIG. 9 shows a block diagram of a transport plan step creator.

FIG. 10 shows a computer system that is programmed or otherwise configured to implement the personal transportation management system described herein.

FIG. 11 shows an example of a personal transportation management system.

FIG. 12 shows an example of a vehicle database.

FIG. 13 shows examples of data processed or used by the transportation plan generator.

FIG. 14 shows an example of a transportation plan execution engine.

FIG. 15 illustrates an example of the data stored in the user database and vehicle database accessed by various applications.

### DETAILED DESCRIPTION

While various embodiments have been shown and described herein, it will be obvious to those skilled in the art that such embodiments are provided by way of example only. Numerous variations, changes, and substitutions may occur to those skilled in the art without departing from the present disclosure. It should be understood that various alternatives to the embodiments described herein may be employed.

As used herein, the terms “autonomously controlled”, “self-driving”, “autonomous”, and “pilotless,” when used in describing a vehicle, generally refer to a vehicle that can itself perform all driving tasks and monitor driving environment along at least a portion of a route. An autonomous vehicle may travel from one point to another without any intervention from a human onboard the autonomous vehicle. In some cases, an autonomous vehicle may refer to a vehicle with capabilities as specified in the National Highway Traffic Safety Administration (NHTSA) definitions for vehicle automation, and specifically Level 4 of the NHTSA definitions, “an Automated Driving System (ADS) on the vehicle can itself perform all driving tasks and monitor the driving environment—essentially, do all the driving—in certain circumstances. The human need not pay attention in those circumstances,” or Level 5 of the NHTSA definitions, “an Automated Driving System (ADS) on the vehicle can do all the driving in all circumstances. The human occupants are just passengers and need never be involved in driving.” In some cases, an automated vehicle may refer to a vehicle with capabilities specified in the Level 2 of the NHTSA definitions, “an advanced driver assistance system (ADAS) on the vehicle can itself actually control both steering and braking/accelerating simultaneously under some circumstances. The human driver must continue to pay full attention (“monitor the driving environment”) at all times and perform the rest of the driving task,” or Level 3 of the NHTSA definitions, “an Automated Driving System (ADS) on the vehicle can itself perform all aspects of the driving task under some circumstances. In those circumstances, the human driver must be ready to take back control at any time when the ADS requests the human driver to do so. In all other circumstances, the human driver performs the driving task.” The automated vehicle may also include those with Level 2+ automated driving capabilities where AI is used to improve upon Level 2 ADAS, while consistent driver control is still required.

The term “passenger vehicle,” as used herein, generally refers to a vehicle used for passengers, such as a car or a truck, but excluding mass transit vehicles.

The term “mass transit vehicle,” as used herein, generally refers to a multi-passenger vehicle, such as a train or a bus, which can transport a group or groups of passengers.

As used herein, the term “trip” generally refers to the total time and/or route(s) taken from a first location to a second location. A trip may include one or more routes. The term “route” generally refers to a set of one or more directions that permit a user to travel from the first location to the second location. A route can have one or more segments. A segment may refer to a part of portion of a route between an embarkation point and a disembarkation point.

The term “contextual information,” as used herein, generally refers to any information associated with a geographic location and/or an event. Contextual information may be derived from information indicative of or related to such geographic location and/or event.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

### Methods and Systems for Facilitating Commerce Along a Route

The present disclosure provides systems and methods that may be capable of personalizing a consumer's transportation experience in and out of a vehicle. Systems and methods of the present disclosure may provide a platform for passenger commerce. Passenger commerce may include, for example, activities and services related to: a) subscriptions to access content, e.g., an annual subscription to a music streaming service, a news service, a concierge service, etc.; b) transaction-based purchase of goods, services, and content while being transported, as well as when vehicles intermittently stop, such as at refueling stations, restaurants, coffee shops, etc. (e.g., a recharging station operator, such as an energy company, can partner with a coffee shop chain to offer discounts in coffee drinks to passengers who purchase while refueling a vehicle); and c) redemption of loyalty points, e.g., automakers and fleet operators can reward their customers for their loyalty, using a system similar to that used by airlines or hotel chains where the loyalty points can be redeemed in much the same way these and other industries use such programs. For example, for every 5,000 ridesharing miles in a particular automaker's vehicles, the consumer receives points that are redeemed towards free cellular data to be used in their personal vehicle. Passenger commerce may comprise any type of in-cabin commerce, in-vehicle services or transactions which may be used or referred to interchangeably throughout the specification.

The platform may be capable of generating a personalized transportation plan for a user, to process, recommend, and/or present personalized mobility data, routing data, scheduling data, traffic data, and many other forms of data. In some instances, machine learning techniques can be utilized to create a personalized transportation plan that includes predicted destinations, travel schedules (e.g., begin time, end time), options for transaction-based purchase of goods, services, and content during transportation, types of vehicles (e.g., types of autonomous vehicles such as sedans or vans, brands), types of transportation modes (e.g., autonomous vehicle, public transportation (such as train, light rail, or city bus), shuttle, ride-sharing, ride-hailing, shared trip or private trip, walking, bicycle, e-scooter, taxi, etc.), and others. In particular, the personalized transportation plan may be generated based on various types of data and/or a variety of sources of data, including, but not limited to, social graphs/networks/media, purchase graphs, transportation graphs, demographic information, mobile applications (e.g., calendar, to-do list, weather, vendor or service provider catalogs, etc.), and various others. The data used to generate the transportation plan may include both historical data (e.g., user preferences, transportation history, purchase history, etc.) and plan data (e.g., to-do list data, calendar data, electronic mail data, etc.).

Artificial intelligence, such as machine learning algorithms, may be used to train a predictive model for producing a personalized transportation plan. A machine learning algorithm may be a neural network, for example. Examples of neural networks include a deep neural network, convolutional neural network (CNN), and recurrent neural network (RNN). In some cases, a machine learning algorithm trained model may be pre-trained and implemented on the vehicle system, and the pre-trained model may undergo continual re-training that involves continual tuning of the predictive model or a component of the predictive model (e.g., classifier) to adapt to changes in the implementation environment over time (e.g., changes in the customer/user data, vehicle data, model performance, third-party data, etc).

A user may be pre-registered with the system or subscribed to one or more mobility services provided by the system. A user may be a prospective requestor for a mobility service. A user may utilize a user mobile application to plan a trip from an origin location to a destination location. The application can provide one or more transactional services or passenger commerce options to the user. A user may access services or conduct transactions during the trip via the application. A user may be transported from a first location to a second location with the use of, and/or while having access to, one or more services including mobility services and user experience services provided by the system during the trip. A user may be a driver or a passenger of a vehicle. The user can be any person who is travelling in a vehicle and is subscribed to one or more mobility services provided by the system. In some cases, a user may subscribe to the one or more mobility services as the user is traveling in the vehicle, and need not be subscribed to the mobility service(s) prior to traveling in the vehicle. In other cases, a user may have already subscribed to the one or more mobility services prior to traveling in the vehicle. A user may, at any time, subscribe to one or more additional mobility services, or modify/change an existing subscription.

The vehicle can have various numbers of users. The vehicle can have at least 1, 2, 3, 4, 5, 6, 7, 8, 9, 10 or more users. For example, the vehicle may include a driver and a passenger. In some cases, the vehicle may include only passenger(s) and need not have a human driver.

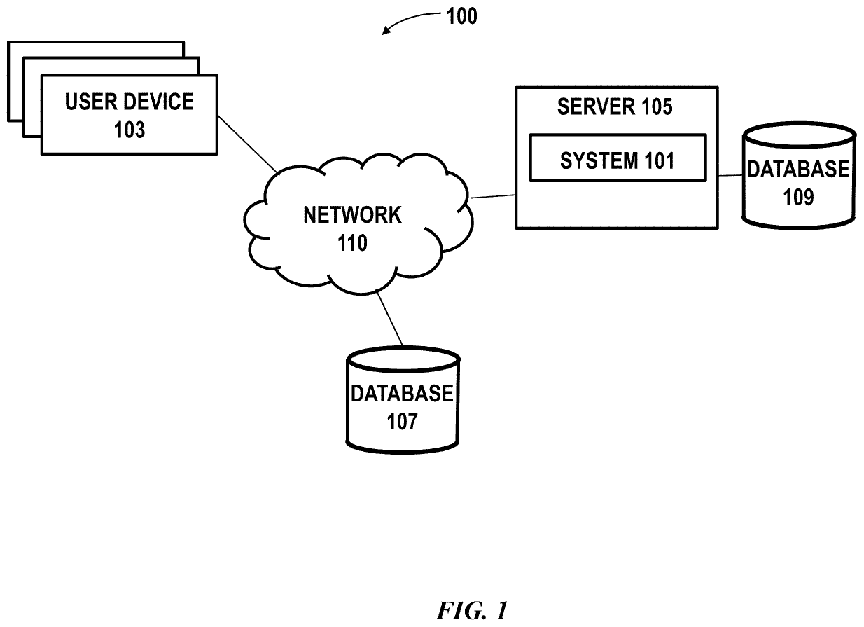

FIG. 1 schematically illustrates an example of a network environment 100 in which a personal transportation management system 101 may be operated. The personal transportation management system 101 may interact with a plurality of user devices 103 through one or more networks 110. The personal transportation management system 101 may be a personal transportation platform for providing a personalized transportation experience including offering personalized services/products during the travel. In some embodiments, a user device of the plurality of user devices 103 may be a device associated with a user. In some embodiments, a user device may be used by a plurality of users. For example, a user device may be a built-in device or system inside or coupled to a vehicle. In some embodiments, two or more user devices may be associated with a single user.

In some embodiments, the personal transportation management system 101 may be configured to provide a user interface for a user to view a travel route and interact with one or more transactional options during a trip via a user device 103. The personal transportation management system may be configured to generate a personalized transportation plan including a travel route, schedule of departure time and arrival time of one or more segments or at one or more stops during the travel, transportation mode (e.g., type of transportation, type/brand of vehicles, configuration of a vehicle, etc) for a segment of the travel route, and one or more services or passenger commerce (e.g., digital service, transactional events or business activities) during the travel. In some instances, the personalized transportation plan may also include transporting the user through at least one segment using an autonomous vehicle.

The personalized transportation plan may be generated based on data related to the user and/or data related to transactional services. The data related to the user may include historical data such as user preferences, transportation history, purchase history of goods and services, and plan data such as to-do list data and calendar data. Such data may be collected from a variety of data sources such as mobile applications (e.g., calendar app, to-do list app, email, text messages, map, social network app, personal health apps, etc), social network software, third-party service providers such as mobility service providers (e.g., Uber® and Lyft®), vendors, business entities (e.g., fast food, restaurants, coffee shops, hospitality, convenience stores, refueling stations, theaters, etc), content providers (e.g., Apple Music®, video, games, etc), digital virtual assistant, smart home device such as Alexa®, interactive voice response (IVR) systems, social media channel and messenger APIs such as Facebook® channel, Twilio SMS channel, Skype® channel, and various other sources. Data related to transactional services may include a rejection or acceptance of a prior transactional service by the user or data from third-party service providers. The personalized transportation plan can be generated using a machine learning based model. The input data may be data derived from the varieties of data as described above. For instance, the input data may include social graph/networks, purchase graph, transportation graph, demographic information, weather data, vender or service provider catalogs and various others. The output of the model may be a travel route, schedule of one or more segments of the travel route (e.g., departure time, arrival time, etc), a transportation mode for each segment (e.g., vehicles, types of a car), and one or more transactional options or services during the travel. In some cases, a transactional offer may be provided by the system in real-time. For example, upon receiving a user input indicative of rejection on a service offer, a new transactional offer may be selected and provided to the user in real-time. Details about generating a personalized transportation plan are described elsewhere herein.

Real-time, as used herein, generally refers to a response time that does not appear to be of substantial delay to a user as graphical elements are pushed to the user via a user interface. In some embodiments, a response time may be associated with processing of data, such as by a computer processor, and may be less than 2 seconds, 1 second, tenth of a second, hundredth of a second, a millisecond, or less. Real-time can also refer to a simultaneous or substantially simultaneous occurrence of a first event with respect to occurrence of a second event.

The personal transportation management system 101 may comprise one or more servers 105 and one or more database systems 107, 109, which may be configured for storing or retrieving relevant data. Relevant data may comprise the user profile data (e.g., user preferences, personal data such as identity, age, gender, contact information, demographic data, ratings, etc), historical data (e.g., social graph, transportation history, transportation subscription plan data, purchase or transaction history, loyalty programs, plan data such as calendar data and to-do list, etc) and various other data as described elsewhere herein. In some cases, the relevant data may comprise map information that is used to plan a route or calculate estimated time of departure/arrival. In some cases, the personal transportation management system may source data or otherwise communicate (e.g., via the one or more networks 110) with one or more external systems or data sources, such as one or more map, weather, or traffic application program interface (API) or map database. In some instances, the personal transportation management system may retrieve data from the database systems 107, 109 which are in communication with the one or more external systems (e.g., mobility service providers, autonomous vehicle dispatching system, third-party passenger commerce entities such as fast food, restaurants, coffee shops, hospitality, convenience stores, refueling stations, theaters, digital service providers, etc). In some cases, the database may be a synchronization database that maintains tables or records for information such as weather, traffic, public transit, Global Positioning System (GPS) input or logs, planning data, personal data and other data obtained from external data sources.

Each of the components (e.g., servers, database systems, user devices, external systems, and the like) may be operatively connected to one another via one or more networks 110 or any type of communication links that allows transmission of data from one component to another. For example, the respective hardware components may comprise network adaptors allowing unidirectional and/or bidirectional communication with one or more networks. For instance, the servers and database systems may be in communication—via the one or more networks 110—with the user devices 103 and/or data sources to transmit and/or receive relevant data.

A server (e.g., servers 105) may include a web server, a mobile application server, an enterprise server, or any other type of computer server, and can be computer programmed to accept requests (e.g., HTTP, or other protocols that can initiate data transmission) from a computing device (e.g., user device, other servers) and to serve the computing device with requested data. A server may be a unitary server or a distributed server spanning multiple computers or multiple datacenters. The servers may be of various types, such as, for example and without limitation, web server, news server, mail server, message server, advertising server, file server, application server, exchange server, database server, proxy server, another server suitable for performing functions or processes described herein, or any combination thereof. In addition, a server can be a broadcasting facility, such as free-to-air, cable, satellite, and other broadcasting facility, for distributing data. A server may also be a server in a data network (e.g., a cloud computing network).

A server may include various computing components, such as one or more processors, one or more memory devices storing software instructions executed by the processor(s), and data. A server can have one or more processors and at least one memory for storing program instructions. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs, special purpose computers, or general purpose computers.

The one or more databases 107, 109 may utilize any suitable database techniques. For instance, structured query language (SQL) or “NoSQL” database may be utilized for storing the user profile data, historical data, predictive model or algorithms used for generating a personalized transportation plan, map or other data. Some of the databases may be implemented using various standard data-structures, such as an array, hash, (linked) list, struct, structured text file (e.g., XML), table, JavaScript Object Notation (JSON), NOSQL and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. In some embodiments, the database may include a graph database that uses graph structures for semantic queries with nodes, edges and properties to represent and store data. If the database of the present disclosure is implemented as a data-structure, the use of the database of the present disclosure may be integrated into another component such as the component of the present disclosure. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

In some embodiments, the personal transportation management system 101 may construct the database in order to deliver the data to the users or care providers efficiently. For example, the personal transportation management system 101 may provide customized algorithms to extract, transform, and load (ETL) the data. In some embodiments, the personal transportation management system 101 may construct the databases using proprietary database architecture or data structures to provide an efficient database model that is adapted to large scale databases, is easily scalable, is efficient in query and data retrieval, or has reduced memory requirements in comparison to using other data structures. For example, a transportation graph may be stored using a graph data structure with nodes and links presenting relationships between users, relationships between a user and a location, and relationship between locations.

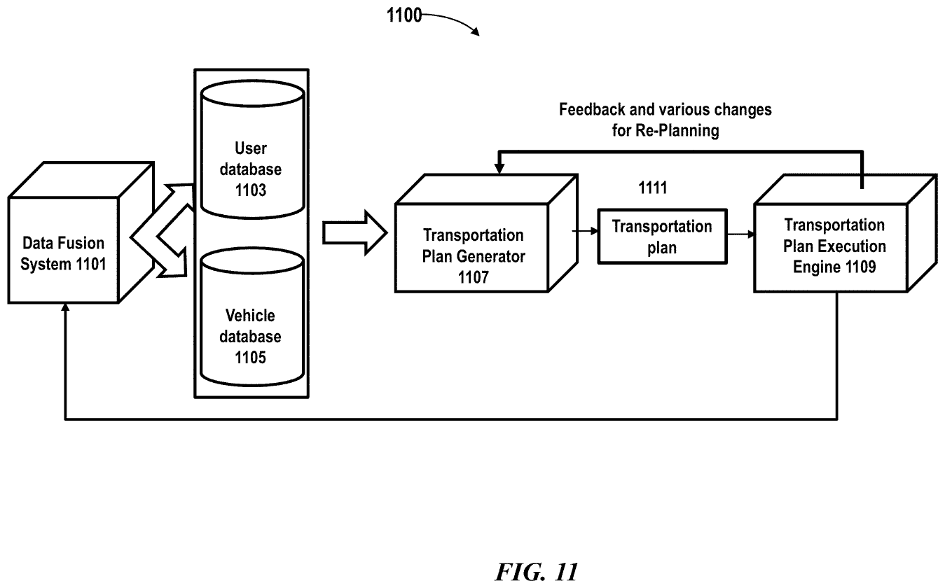

FIG. 11 shows an example of a personal transportation management system 1100. In some cases, the personal transportation management system 1100 may comprise a data fusion system 1101, a user database 1103, a vehicle database 1105, a transportation plan generator 1107 and a transportation plan execution engine 1109.

The data fusion system 1101 may be configured to import and fuse data from a variety of sources to generate or update a profile of a user, and generate or update a profile of a vehicle that is either owned by the user, or a fleet's operator. The fused data may be incorporated into the user database or the vehicle database. The data fusion system 1101 may be configured to pre-process the data using suitable functions. For instance, the plurality of functions for data processing may comprise ingestion, filtering, cleaning, tagging, augmentation, annotation, anonymization, and various others (e.g., simulate). The data fusion system may prepare the data such that it can quickly and easily be accessed via APIs by intended data consumers or applications. In another example, the data fusion system may combine traffic data with purchase data to predict travel time for a fleet pertaining to a user, combine several data sets to create information-rich data, (e.g., combine vehicle operating data, with city transportation infrastructure data, and congestion data to predict vehicle arrival times during specific times of the day). The data fusion system 1101 may comprise an extract-transform-load (ETL) system. The ETL system may perform traditional ETL functionalities or customized functionalities. For instance, the ETL system may transform the ingested batch data or stream data to a format more useful to a user. For example, the data transformation may include selecting only certain columns to load into a format, translating coded values, deriving new calculated values, sorting data, aggregating data, transposing or pivoting data, splitting a column into multiple columns, and other processing.

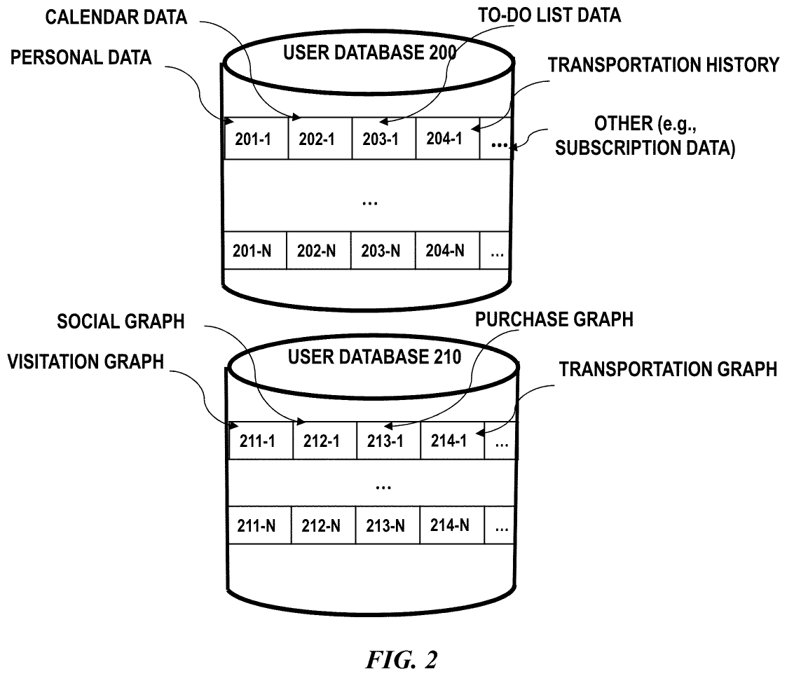

The user database 1103 may manage data related to a user or a user profile. Details about the user database are described in connection with FIG. 2

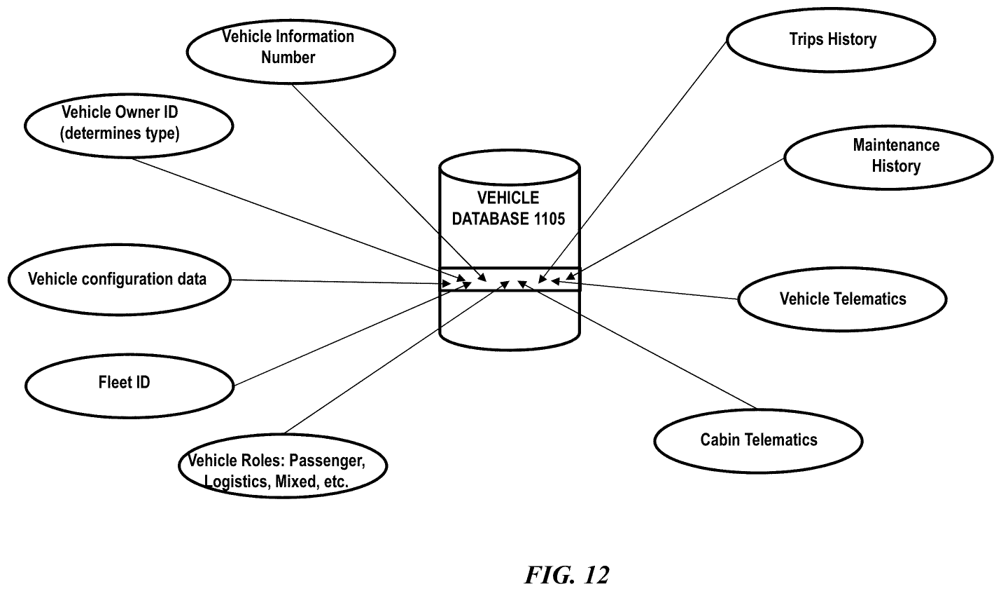

The vehicle database 1105 may be configured to manage the data that is related to a vehicle profile (Privately-Owned, Corporate Fleet-Owned) for each vehicle participating in a given service. FIG. 12 shows examples of data stored in a vehicle database. In these examples, data, such as vehicle owner ID, trips history, vehicle information, vehicle configuration data, fleet ID, vehicle roles (e.g., passenger, logistics, mixed, etc), cabin telematics, vehicle telematics, maintenance history and various other data, may be managed and stored in the vehicle database.

The transportation plan generator 1107 may be configured to generate personalized transportation plan 1111 based on data retrieved from the user database and vehicle database. The transportation plan generator may also be referred to as transportation plan creator or transportation plan step creator which are used interchangeably throughout this specification. In some cases, the transportation plan generator 1107 may comprise a trip creator 1107-1 that is configured to create a trip by synthesizing a plurality of location points. The plurality of location points may include, for example, location of the trip origin, location of the trip destination (e.g., trip end location), and the location(s) of intermediate point(s). The intermediate points can be obtained from the passenger's device, the driver's device, or the vehicle system. These location points may be used to synthesize a route or the entire trip. In some cases, user-defined and/or publicly available Points of Interest (POIs) that are encountered during the trip may be marked in the synthesized trip which may be used as decision making points to determine what transactional options to be provided to the passenger. In some cases, the transportation plan generator may use a consumer/subscriber ID and associated location points (e.g., latitude/longitude) and automatically create a time series of trips for the consumer/subscriber ID.

In some embodiments, the transportation plan generator 1107 may be capable of automatically identifying or characterizing a trip type (e.g., commute to work, business travel, daily trip, vacation trip, shopping trip, trip to the airport, etc), identifying or characterizing a user type (e.g., driver, passenger, service driver such as a driver of a ride-hailing service, etc) or identifying the POIs at the origin, destination, and at any point or location during the trip.

The transportation plan generator 1107 may comprise a trip classifier 1107-3 that is configured to predict the type of the next trip based on data retrieved from the user database and vehicle database. The type of trip may be predicted using a trained predictive model (e.g., support vector machine or neural network). In some case, the type of trip may be predicted based at least in part on a segment to which the user is assigned (which is described in the following paragraph). In some cases, the predictive model may be a machine learning algorithm trained model that can be pre-trained and implemented on the vehicle system, and the pre-trained model may undergo continual re-training that involves continual tuning of the predictive model or a component of the predictive model (e.g., classifier) to adapt to changes in the implementation environment over time (e.g., changes in the customer/user data, vehicle data, model performance, third-party data, etc).

The transportation plan generator 1107 may comprise a user/customer segmentation module 1107-2. The customer segmentation may allow the system to target a certain segment of the subscribers to make offers that may be relevant (e.g., found to be most relevant) to those subscribers. The subscribers or users may be segmented (or organized into one or more segments) using any suitable segmentation technique. For example, the segmentation technique may be based on fixed rule sets. Subscribers may be grouped based on geography (or geolocation), social graph(s), purchase graph(s), transportation graph(s), demographic information, user preference(s), installed mobile application(s), or other user attribute(s) or characteristic(s) extracted from the user profile data, as described above. Subscribers in the same group may share one or more user attributes or subscriber characteristics (e.g., age, gender, geolocation, social graph, frequent flyer, frequent food shopper, etc). An individual may belong to one or more segments. In some cases, the segments may be continuously augmented and updated automatically as new data is collected. In some embodiments, new segments may be created as new users (or classes of users) are added to or subscribed to the system. In some cases, the segments may be discrete. In other cases, two or segments may overlap, and may share a set of commonalities or characteristics.

In some cases, the segmentation technique may be based on a pattern extracted from historical data (e.g., user profile data). The pattern may be extracted using a machine learning algorithm. In some cases, a set of patterns may be initially generated and an algorithm may be employed to identify an optimal allocation of patterns to segments that is both feasible and maximize a desired outcome. The desired outcome may be offering a small number of in-vehicle service or transaction options to be sent to appropriately chosen customers (e.g., group of customers) at the appropriate time and/or location such that the chosen customers are likeliest to accept the in-vehicle service. The initial set of patterns may be generated using any suitable method such as a decision tree or other pattern identification algorithm. In some cases, the algorithm for identifying an optimal allocation of patterns to segments may be a trained machine learning algorithm (e.g., support vector machine or neural network).

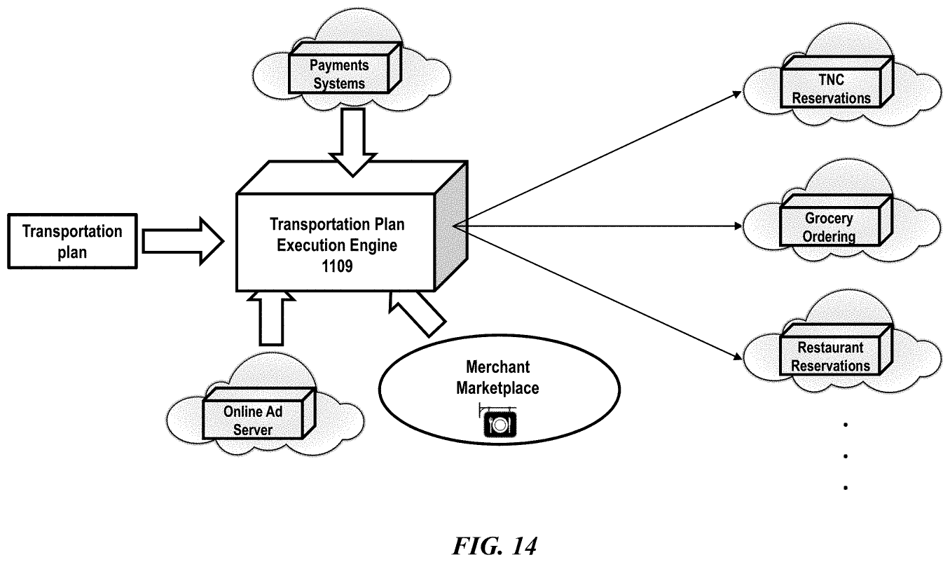

A transportation plan is executed by a transportation plan execution engine 1109. The personal transportation management system 1100 may be capable of updating a transportation plan automatically. For instance, the transportation plan execution engine may look for updates of data prior to execution of a transportation plan. As an example, upon detection of a new calendar entry is added, an existing calendar entry is modified, or a new task is added to the to-do list, the personal transportation management system 1100 may re-create and update the transportation plan. Once a plan is executed, the new data that is created as a result may be updated in the user database and/or the vehicle database. In some cases, the transportation plan execution engine may be configured to be in communication with suitable entities (e.g., third-party systems) to execute a transportation plan. FIG. 14 shows an example of a transportation plan execution engine 1109. In some cases, the provided system may maintain a list of partners (e.g., Merchant Marketplace). When the transportation plan generator determines what transactional offers to include in a given plan, the transportation plan generator may access the list of partners. The list of partners (e.g., Merchant Marketplace) may also be used by the transportation plan execution engine to determine which external systems to access based on the transportation plan that is generated by the transportation plan generator. As illustrated in the example, the transportation plan execution engine may utilize machine learning techniques in the process of executing a user's daily plan. During the execution, the transportation plan execution engine may interface with the Merchant Marketplace, the systems of each partner in the Merchant Marketplace such as TNC reservation systems, restaurant reservation systems, grocery ordering systems, an online advertising server, or a payment system.

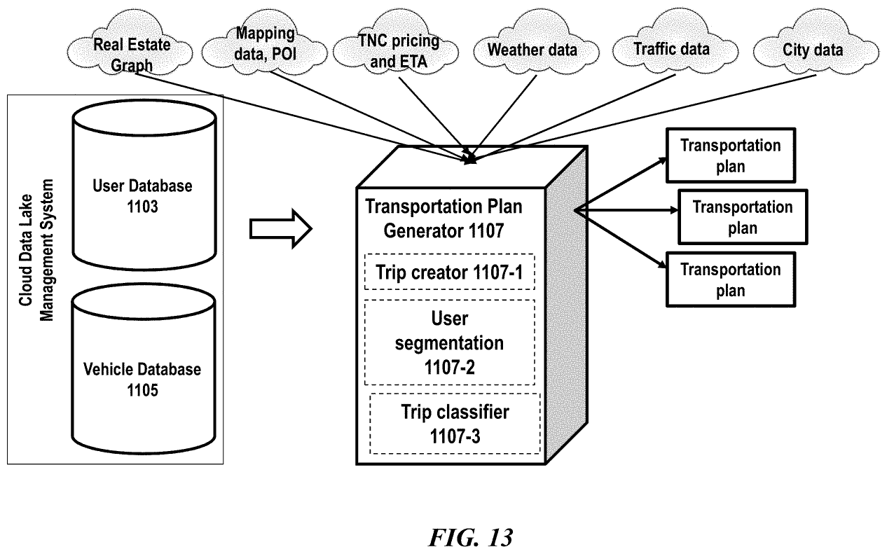

FIG. 13 shows examples of data processed or used by the transportation plan generator 1107. The transportation plan generator may be configured to analyze user data, vehicle data (e.g., data stored in the vehicle database or real-time vehicle data), and third-party data, and use machine learning, planning, and reasoning algorithms to create a transportation plan that is tailored to each user on a day-by-day basis, and updated as-necessary in near real-time during the day. The various data used by the transportation plan generator are described with respect to FIG. 2, FIG. 11 and FIG. 12. For example, the data may include real-estate graph, mapping data, TNC pricing and ETA data, weather data, traffic data, city data and various others.

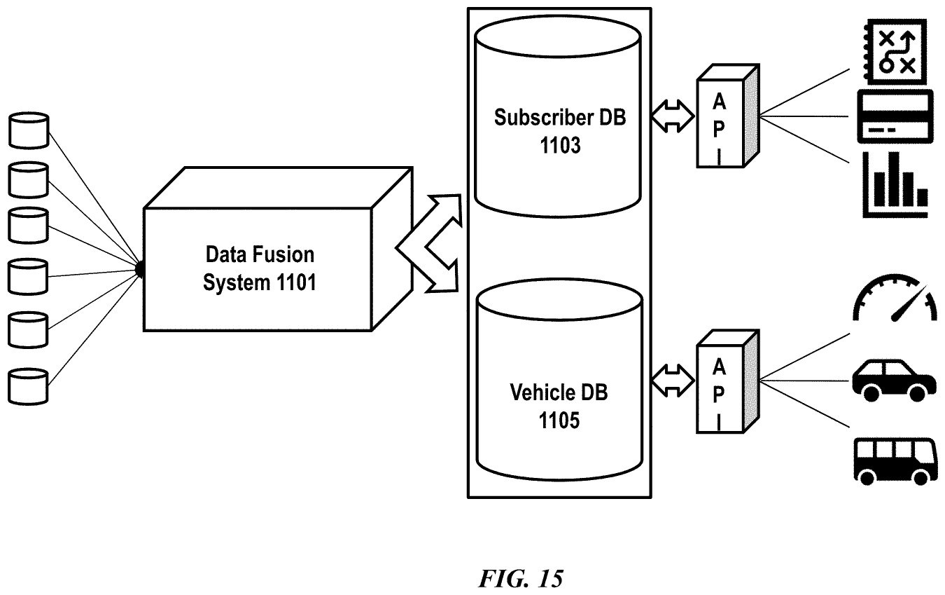

The user database and/or the vehicle database can be accessed by a variety of applications or entities that may be related to transactions, though in some situations some of the applications or entities may not be related to transactions. FIG. 15 illustrates an example of the data stored in the user database and vehicle database accessed by various applications. In some cases, data stored in the user database and/or vehicle database can be utilized or accessed by other applications through APIs (application programming interfaces). The data accessed by the variety of applications may include data generated by the transportation plan generator (e.g., Personal Daily Plans) and/or data collected from the vehicles or user devices. For example, the system may be in communication with a Fleet Coordination Application that uses the collection of plans created by the transportation plan generator during each particular day to coordinate and manage the fleet of vehicles that are controlled by the fleet operator. By accessing that data the fleet operator may better coordinate and manage the vehicles that are available for use each day, thus achieving better per vehicle economics and higher subscriber satisfaction with the overall transportation service. Access to the database may be authorized at per API level, per data level (e.g., type of data), per application level or according to other authorization policies.

The personal transportation management system 101 may be implemented anywhere in the network. The personal transportation management system 101 may be implemented on one or more servers in the network, in one or more databases in the network, one or more electronic devices built in or coupled to a vehicle, or one or more user devices. For example, the personal transportation management system 101 may be implemented in a distributed architecture (e.g., a plurality of devices collectively performing together to implement or otherwise execute the personal transportation management system 101 or its operations) or in a duplicate manner (e.g., a plurality of devices each implementing or otherwise executing the personal transportation management system 101 or its operations as a standalone system). The personal transportation management system 101 may be implemented using software, hardware, or a combination of software and hardware in one or more of the above-mentioned components within the network environment 100.

A user device of the plurality of user devices 103 may be an electronic device. The user device may be a computing device configured to perform one or more operations consistent with the disclosed embodiments. Examples of user devices may include, but are not limited to, mobile devices, smartphones/cellphones, tablets, personal digital assistants (PDAs), smart wearable devices, smart watches, laptop or notebook computers, desktop computers, media content players, television sets, video gaming station/system, virtual reality systems, augmented reality systems, microphones, or any electronic device configured to enable the user to view the travel route, and interact with the transaction or service related information, and display other information as it relates to the travel, for example. The user device may be a handheld object. The user device may be portable. The user device may be carried by a human user. In some cases, the user device may be located remotely from a human user, and the user can control the user device using wireless and/or wired communications. The user device may be a computing device in communication with a wearable device worn by a user. In some cases, the wearable device may be configured to monitor user activities, vital signs (e.g., blood pressure and heart rate) or health conditions of a user. In some cases, the user device may be an electronic device coupled to or located on-board a vehicle.

In some embodiments, the user device may be capable of detecting a location of the device/user. The user device may have one or more sensors on-board the device to provide instantaneous positional or location information of the user device. In some embodiments, the instantaneous location information may be provided by sensors such as a location sensor (e.g., Global Positioning System (GPS)), inertial sensors (e.g., accelerometers, gyroscopes, inertial measurement units (IMUs)), altitude sensors, attitude sensors (e.g., compasses) pressure sensors (e.g., barometers), field sensors (e.g., magnetometers, electromagnetic sensors), and/or other sensor information (e.g., WiFi data). The location of the user device can be used to locate an origin of a travel route. As an addition or alternative, a location of a place of interest (e.g., origin of a trip, destination of a trip, stops during a trip) may be provided by a user via the user device 103 such as by manually entering a location via a user interface.

The user device may include a communication unit, which may permit the communications with one or more other components in the network. In some instances, the communication unit may include a single communication module, or multiple communication modules. In some instances, the user device may be capable of interacting with one or more components in the network environment using a single communication link or multiple different types of communication links. The user devices 103 may interact with the personal transportation management system 101 by requesting and obtaining the aforementioned data via the network 110.

The user device may include one or more processors that are capable of executing non-transitory computer readable media that may provide instructions for one or more operations consistent with the disclosed embodiments. The user device may include one or more memory storage devices comprising non-transitory computer readable media including code, logic, or instructions for performing the one or more operations.

In some embodiments, users may utilize the user devices 103 to interact with the personal transportation management system 101 by way of one or more software applications (i.e., client software) running on and/or accessed by the user devices, wherein the user devices 103 and the personal transportation management system 101 may form a client-server relationship. For example, the user devices 103 may run dedicated mobile applications provided by the personal transportation management system 101.

In some embodiments, the client software (i.e., software applications installed on the user devices 103) may be available either as downloadable mobile applications for various types of mobile devices. Alternatively, the client software can be implemented in a combination of one or more programming languages and markup languages for execution by various web browsers. For example, the client software can be executed in web browsers that support JavaScript and HTML rendering, such as Chrome, Mozilla Firefox, Internet Explorer, Safari, and any other compatible web browsers. The various embodiments of client software applications may be compiled for various devices, across multiple platforms, and may be optimized for their respective native platforms. In some cases, third-party user interfaces or APIs may be integrated to the mobile application and integrated in the front-end user interface (e.g., within a graphical user interface). The third-party user interfaces may be hosted by a third party server. In some cases, APIs or third-party resources (e.g., map service provider, mobility service provider, digital service provider, Starbucks, McDonalds, Ticketmaster, etc) may be used to provide and conduct a transaction with the user. In some cases, one or more third-party services may be called by the personal transportation management system 101 and integrated to the user application such that a user may access such services in a familiar front-end user experience. In some cases, one or more of the aforementioned services may be a built-in component of the personal transportation management system 101 and may be provided to the user without outsourcing a third-party entity. In some cases, data retrieved from the third-party service providers may be organized and stored by the personal transportation management system 101 to form a vendor/service catalog which may be used to determine a transactional offer to the user during transportation. In some cases, the personal transportation management system 101 may provide a graphical user interface (GUI). The GUI may permit the user to access, accept, reject, select one or more transactional offers/options by interacting with graphical elements, and viewing information such as a travel route and travel schedule during the transportation.

The user device may include a display. The display may be a screen. The display may be a touchscreen. As an alternative, the display may not be a touchscreen. The display may be a light-emitting diode (LED) screen, OLED screen, liquid crystal display (LCD) screen, plasma screen, or any other type of screen. The display may be configured to show a user interface (UI) or a graphical user interface (GUI) rendered through an application (e.g., via an application programming interface (API) executed on the user device). For example, the GUI may show graphical elements that permit a user to accept or reject a transactional offer, and view information related to a travel route and transaction options. Alternatively or in addition to, the user device may be any personal digital assistants or devices such as smart watch or smart speaker that may not include a display.

The network 110 may be a communication pathway between the personal transportation management system 101, the user devices 103, and other components of the network. The network may comprise any combination of local area and/or wide area networks using both wireless and/or wired communication systems. For example, the network 110 may include the Internet, as well as mobile telephone networks. In one embodiment, the network 110 uses standard communications technologies and/or protocols. Hence, the network 110 may include links using technologies such as Ethernet, 802.11, worldwide interoperability for microwave access (WiMAX), 2G/3G/4G or Long Term Evolution (LTE) mobile communications protocols, Infra-Red (IR) communication technologies, and/or Wi-Fi, and may be wireless, wired, asynchronous transfer mode (ATM), InfiniBand, PCI Express Advanced Switching, or a combination thereof. Other networking protocols used on the network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), and the like. The data exchanged over the network can be represented using technologies and/or formats including image data in binary form (e.g., Portable Networks Graphics (PNG)), the hypertext markup language (HTML), the extensible markup language (XML), etc. In addition, all or some of links can be encrypted using conventional encryption technologies such as secure sockets layers (SSL), transport layer security (TLS), Internet Protocol security (IPsec), etc. In another embodiment, the entities on the network can use custom and/or dedicated data communications technologies instead of, or in addition to, the ones described above. The network may be wireless, wired, or a combination thereof.

In some embodiments, a user may register with the system or subscribe to the personalized transportation service provided by the system. Data related to the user may be stored in a user database. FIG. 2 shows examples of user databases, 200, 210 in accordance with embodiments of the present disclosure. In some embodiments, a user database 200 may be configured to store personal data, plan data, historical data and others. The user data may be stored for each individual user.

In some cases, personal data 201-1, 201-N may include data related to an individual (e.g., user 1 or user N) such as identity, age, gender, contact information, demographic data and others. Such data may be inputted by the user during a registration process or after registration. Alternatively or in addition to, such data may be extracted from other data sources or third party applications. In some cases, personal data may also include user preferences.

User preferences may include both travel preference and transactional/service preferences. The travel preference may be derived from one or more of various parameters acquired by the system, and used to generate a personalized travel route. For example, a travel preference such as a “fastest route” preference indicates a preference for the fastest (temporally) route between two points. A “shortest route” preference can indicate a preference for the shortest (distance) route between two points. A “most fuel-efficient route” preference can indicate a preference for fuel savings. A travel preference may indicate a preference for “effort” that may be especially relevant to cyclists, walkers, runners, hikers, and swimmers that may want, for example, large changes in grade (e.g., hills) or small changes in grade (e.g., flat). A travel preference may indicate a preference for a route with various scenic points, more vegetation than urban vistas, and the like, a preference for museums, theaters, playhouses, and the like, a preference for routes that include shopping opportunities, a preference for food, a preference by a user to avoid being stuck in traffic, even if the traffic-heavy route is the fastest path to their destination and various other preferences. A travel preference may include user-preferred transportation mode (e.g., autonomous vehicle, public transportation (such as train, light rail, or city bus), shuttle, ride-sharing, ride-hailing, shared trip or private trip, walking, bicycle, e-scooter, taxi, etc.), or user experience inside a vehicle (e.g., access to music, game) and the like. The travel preferences may be used to determine the travel route, segments of a route, and/or stops (e.g., scenic views, restaurants, coffee shops, etc) during the travel route. Such user preferences may be inputted by the user and/or extracted from other data sources or historical data.

In some cases, plan data may include calendar data 202-1, 202-N and to-do list data 203-1, 203-N. Calendar data or to-do list data may be collected from a calendar application or to-do list application running on the user device. In some cases, such plan data may also include data extracted from electronic mails (emails), text messages, or other planning, communication, or scheduling applications or channels.

The historical data may include transportation, purchase, and/or transaction history of the user. In some cases, an entry of a transportation history 204-1, 204-N may include data related to a trip or transportation. For example, an entry of a transportation history may comprise one or more of trip date, origin location, destination location, starting time, end time, transportation mode (e.g., autonomous vehicle, public transportation (such as train, rail, or city bus), shuttle, ride-sharing, ride-hailing service, shared trip or private trip, walking, bicycle, e-scooter, taxi, etc.) offered to the user, transportation mode selected by the user, price, wait time, vehicle type, interior configuration of a vehicle, configuration for each segment of the trip, calendar entry addressed, to-do list entry addressed, health inference based on transportation mode, ratings of the service, reputation score, customer complaints, and other historical data. Such historical data may be automatically recorded or tracked by the system. For instance, a transaction record may be stored in the user database when a transaction is completed.

The user database may comprise any other data related to the user. For instance, information related to loyalty programs (e.g., loyalty points), subscription data, ratings of the user may be stored in the user database.

In some instances, data derived from the aforementioned data may be stored in a user database 210. The database 210 for storing derived data can be integral to the user database 200 as described above. In some cases, the user database 210 may be a graph database. For example, the derived data may be stored as a graph data structure. Alternatively or addition to, the database 210 may utilize any other suitable database techniques. In some cases, the derived data may include a visitation graph 211-1, 211-N, a social graph 212-1, 212-N, a purchase graph 213-1, 213-N, a transportation graph, 214-1, 214-N, and various other data.

A social graph 212-1 may help depict relationships between various users. In some cases, a social graph may also depict vehicles to facilitate in-car sharing, among other things. In some cases, a social graph may indicate the relationship between the user and other individuals and entities (e.g., family, business, friend, etc), a road network, and potential meeting-spots within a community. In some cases, the social graph may be used for facilitating car sharing, offering recommended vehicles and locations, suggesting car sharing partners based on shared interests and mobility activities. In some cases, the social graph may be used to predict or recommend a location and/or schedule for the trip. For example, if the user is scheduled to meet someone in a business relationship with the user, the arrival time may be scheduled based on a business meeting preference. In some instances, a social graph may represent users as nodes and represent relationships between users as links. In some cases, the social graph may include properties related to the links or nodes. Links may arise from physical proximity, social networks (e.g., Facebook, Twitter, LinkedIn, etc.), historical communications (e.g., email, SMS, video chat, etc.), common membership in clubs, common membership in organizations, common membership and societies, family relationships, common employer, common workplace, and the like. Links can be established primarily for forming a vehicle sharing community. Each of the link properties may be a factor and may be weighted dynamically and/or individually for the social graph.

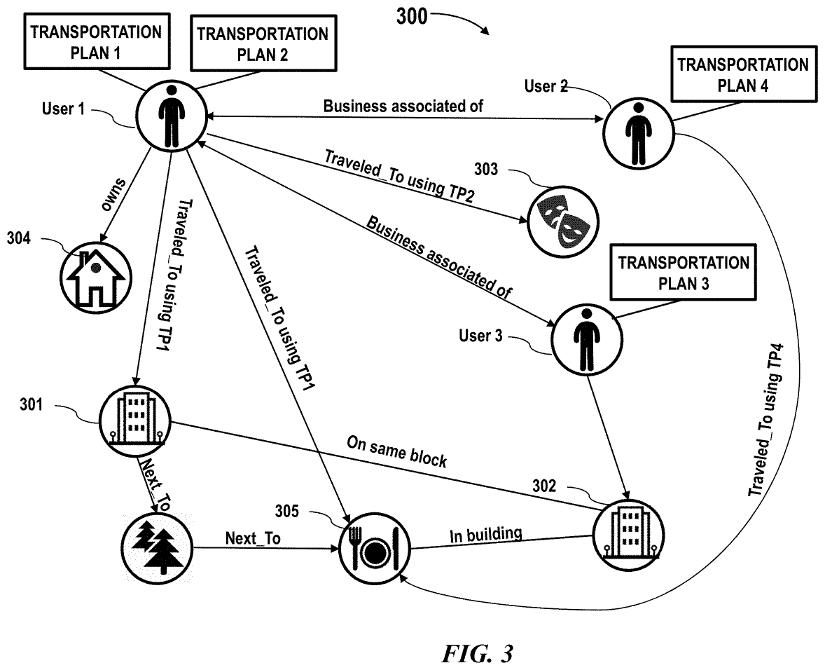

A transportation graph 214-1, 214-N may depict one or more relationships connecting people, places, and transportation plans. FIG. 3 shows an example of a transportation graph. In some cases, the transportation graph may comprise nodes representing people (e.g., user 1, user 2, user 3) and stationary locations (e.g., building 302, restaurants 305, museums, parks, theater 303, home 304, work place 301, bus stop, etc). In some cases, properties such as one or more transportation plans may be stored with a node corresponding to a user. A transportation plan may include a transportation mode (e.g., autonomous vehicle, public transportation (such as train, light rail, or city bus), shuttle, ride-sharing, ride-hailing, shared trip or private trip, walking, bicycle, e-scooter, taxi, etc.). Properties such as address may be stored with nodes corresponding to locations. The links connecting places may represent geolocation or temporal relationships (e.g., next_to, on same block, in building, etc). The links connecting a user and a place may represent a transportation relationship including a property indicating transportation mode (e.g., Traveled_To using transportation plan 1) or other relationships (e.g., owns). In some cases, the links connecting users may represent social relationships (e.g., business associated of). A transportation plan may be carried out in a time period that may be within a day, span across multiple days and the like. A transportation plan may comprise a start time and an end time. In some cases, multiple transportation plans associated with a user may be arranged according to the start time.

Referring back to FIG. 2, the visitation graph 211-1, 211-N may depict relationships between the user and various places/locations that were visited by the user at least once. In some cases, the visitation graph and the transportation graph may share same data or information. In some cases, the visitation graph may comprise additional or different information such as the frequency of visiting a place.

In some cases, the in-vehicle service or transaction options may be offered to users based on customer segmentation. The customer segmentation may allow the system to target a certain segment of the subscribers to make offers that may be relevant (e.g., found to be most relevant) to those subscribers. The subscribers or users may be segmented using any suitable segmentation technique. For example, the segmentation technique may be based on fixed rule sets. Subscribers may be grouped based on geography (or geolocation), social graph(s), purchase graph(s), transportation graph(s), demographic information, user preference(s), installed mobile application(s), or other user attribute(s) or characteristic(s) extracted from the user profile data, as described above. Subscribers in the same group may share one or more user attributes or subscriber characteristics (e.g., age, gender, geolocation, social graph, frequent flyer, frequent food shopper, etc). An individual may belong to one or more segments. In some cases, the segments may be continuously augmented and updated automatically as new data is collected.

In some cases, the segmentation technique may be based on a pattern extracted from historical data (e.g., user profile data). The pattern may be extracted using a machine learning algorithm. In some cases, a set of patterns may be initially generated and an algorithm may be employed to identify an optimal allocation of patterns to segments that is both feasible and maximize a desired outcome. The desired outcome may be offering a select number of in-vehicle service or transaction options to be sent to appropriately chosen customers (e.g., a target group of customers) at an appropriate time and/or location such that the chosen customers are likeliest to accept the in-vehicle service. The initial set of patterns may be generated using any suitable method such as a decision tree or other pattern identification algorithm. In some cases, the algorithm for identifying an optimal allocation of patterns to segments may be a trained machine learning algorithm (e.g., support vector machine or neural network).

Data related to the customer segmentation may be stored in the subscriber database. The user data may be stored and organized in the subscribed database according to customer segments. The customer segmentation may be updated periodically or upon detection of new data being added to the subscriber database. Such update(s) may be performed automatically or manually.

When a new user registers with the system or subscribes to the personalized transportation service provided by the system, the user may be assigned to one or more segments. The segment to which the user is assigned may be updated with time. In-vehicle service or transaction options associated with a given customer segment may be updated as new data (e.g., purchase data, transaction data, transportation data, etc) are collected and analyzed by the system.

A transportation plan may be personalized for an individual based on the aforementioned data. In some embodiments, a travel route may be generated automatically upon receiving an origin location and a destination location. The travel route may comprise one or more segments. In some cases, the personalized transportation plan may also include a transportation mode determined for each segment and a schedule (e.g., departure/begin time, arrival/end time for the trip or a segment). The personalized transportation plan may also include offering one or more transactional options to the user during the transportation. A user may conduct one or more transactions facilitated by the system. In some cases, the destination or a stop during the trip may be predicted by the system based on calendar data and/or to-do list data. In some cases, a stop (e.g., coffee shop) during the trip or a next destination may be predicted by the system based on user data (e.g., historical data) or a combination of plan data (e.g., calendar data and/or to-do list data) and historical data.

The present disclosure also provides methods and systems for providing a passenger with a personalized trip experience that may be based at least in part on a context of a destination or a stop of the passenger along a trip. The destination or stop during the trip may be analyzed by the system to extract contextual information. Such contextual information may be used to determine one or more transactional options, vehicle options, and/or in-vehicle settings for personalizing the trip. The contextual information may be relevant to or indicate a likely or an actual (e.g., predetermined) action. For example, the contextual information, such as a coffee shop, a flight to a particular destination (e.g., a flight from San Francisco to New York), restaurant, stadium, theater, or dental clinic may be relevant to activities such as drinking coffee, business trip, dining, attending a football game, attending a show, getting dental treatment or any other type of medical examination and/or test and the like. Such contextual information may be associated with the identity of the destination or stop, or an event associated with the destination or stop (e.g., a baseball game, a baseball stadium, etc.). In some cases, the contextual information may relate to activities that are typically associated with a particular location. For example, before a domestic flight that is expected to last over 3.5 hours, the passenger flying in a coach class may be offered to order a meal to pick up prior to boarding. In another example, a passenger who is about to attend a theatrical event may be offered a table reservation at the theater's bar for a drink during the performance's intermission. In some cases, the contextual information may be obtained by extracting a data pattern from multiple users' trip data. For instance, by analyzing trips that are arriving at approximately the same time to the same location, such as a residence, it may infer that an event or group activity (e.g., party) is taking place at the location. Based on this contextual information, one or more transactional options or mobility services related to the group activity, such as purchasing a bottle of wine to bring to the party, or ordering food from a vender to be delivered to the party, may be provided to the passenger(s) during the trip.

Based on the contextual information and the likely activities, the trip can be personalized. For instance, one or more in-vehicle settings during a trip may be automatically adjusted based on the destination context. For example, if the destination context (e.g., dental clinic) indicates a medical treatment to be taken at the destination, the temperature, humidity, air freshener, or music service may be adjusted to provide a comfort in-vehicle ambient environment and help the passenger relax. In another example, if the destination context (e.g., Starbucks) indicates the user will have coffee at the destination, the user may not be offered coffee transactions during the trip. In some cases, the in-vehicle services or transactions may be offered to a passenger in a personalized manner based on the destination context. For example, in-vehicle services such as a wake-up service or massage service may be personalized based on the time of arrival at the destination location and the destination context. In some cases, the associated equipment such as exercise equipment, massage chairs or nap pods, may be automatically set up and controlled based on the personalized service. The contextual information can be extracted using any suitable methods and models, such as, for example, natural language processing (NLP) algorithms, Named Entity Recognition (NER), linguistic analysis, and/or machine learning models (e.g., support vector machine or neural network). In some cases, the contextual information may be extracted from a passenger condition/activity in the vehicle. The contextual information may relate to a passenger's mood, stress level, health condition, passenger behavior (e.g., sleep) or others. For example, one or more sensors, such as electrocardiogram (ECG) sensors, sweat-rate sensors, and/or respiration-rate body sensors, may be used to assess a passenger's stress level, and stress-reduction options, such as music, lighting, and/or humidity level, may be automatically adjusted to reduce the passenger's stress level. Other sensors, such as a vision sensor (e.g., camera) and/or artificial intelligence (AI) techniques, may be used to analyze the passenger's behavior (e.g., sleep) so as to automatically control in-vehicle settings (e.g., music, lighting, and/or humidity level). Such AI may include one or more machine learning algorithms, such as a neural network or support vector machine.

For example, a user may be traveling in a vehicle as a passenger from San Francisco to Santa Clara to attend a football game. The context may be determined to be football and/or the football team. The user's travel experience may be customized to provide the user with music that is specific to football or the football team.

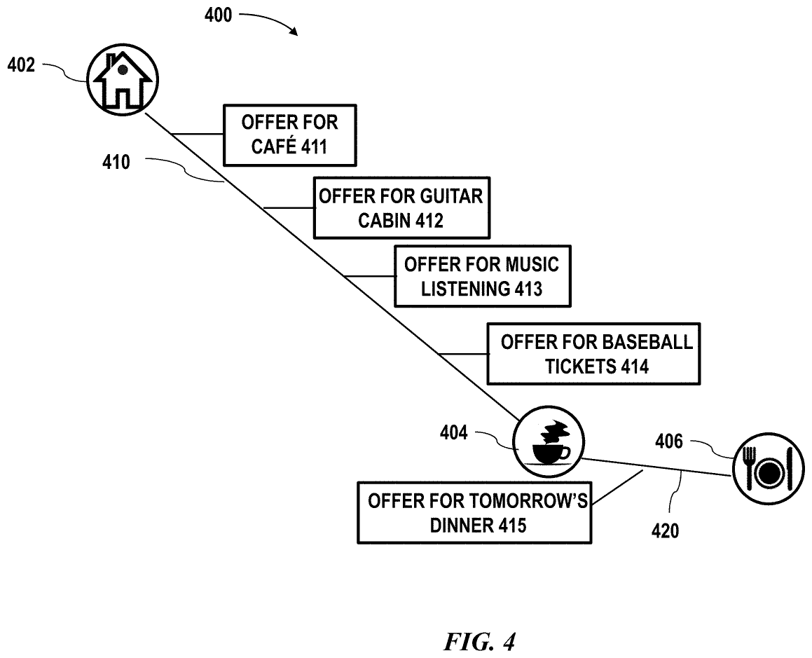

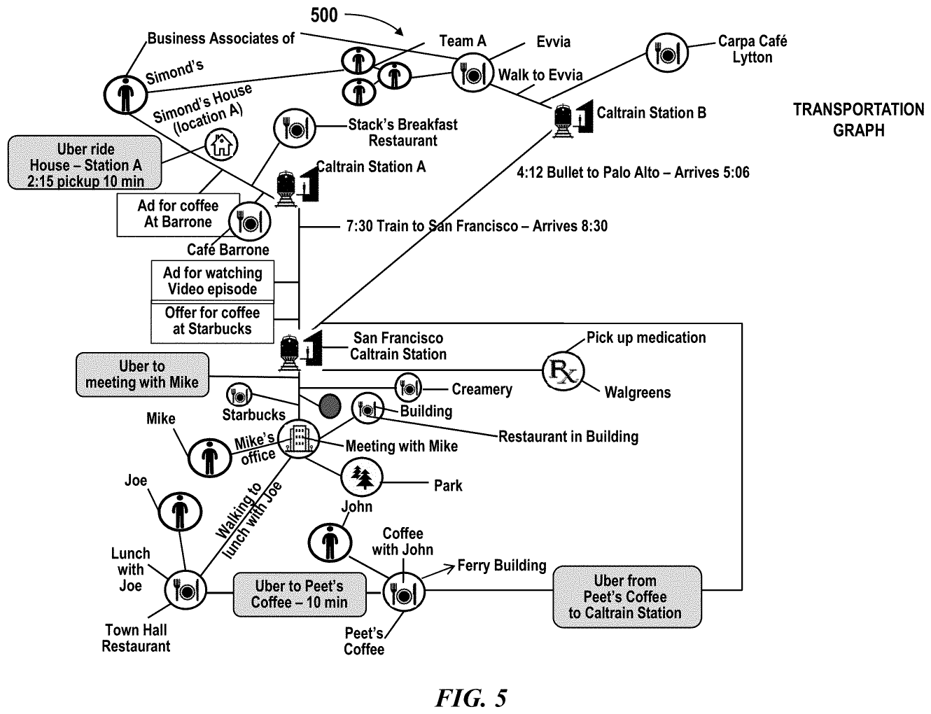

FIG. 4 and FIG. 5 show examples of personalized transportation plans 400, 500. As shown in FIG. 4, the travel route comprises two segments 410, 420. The origin location 402 of the travel route may be inputted by the user via a GUI or automatically detected by a Global Positioning System (GPS) of the user device. The destination location 406 of the travel route may be automatically determined by the system based on calendar data or to-do list data. Alternatively or in addition to, the destination location may be entered by the user.

During transportation along the first segment 410 of the trip, the user may be offered one or more transactional options (e.g., offer for cafe 411, offer for quiet cabin 412, offer for music listening 413, and offer for baseball ticket 414). During the second segment 420, the user may be offered transactional options such as offer for today's dinner 415. Such one or more transactional offers may be presented to the user in a GUI of the user device or on a display in the vehicle. In some cases, one or more stops during the travel route may be generated based on a user response to a transactional offer. In the illustrated example, a user may accept a coffee offer 411 and conduct a transaction. Upon receiving the acceptance, the travel route may be updated with a stop at a coffee shop 404. As described elsewhere herein, a transportation mode (e.g., autonomous vehicle, public transportation (such as train, light rail, or city bus), shuttle, ride-sharing, ride-hailing, shared trip or private trip, walking, bicycle, e-scooter, taxi, etc.) may be determined for each segment. The transportation mode for the first segment 410 may be the same as the transportation mode for the second segment 420. Alternatively, the transportation mode for the first segment may be different from the transportation mode for the second segment.

In some cases, a plurality of transactional options are presented to a user concurrently. Alternatively or in addition to, a plurality of transactional options may be presented to a user sequentially. In some cases, the timing for providing one or more passenger commerce options may be based on a current geolocation of the user and/or travel time. In some cases, a user may not be presented a next transaction option until the previous one is conducted or turned down. The timings and selections of one or more transaction options offered to a user may be determined by a transport plan engine. In some cases, the transport plan engine may include a recommendation engine configured to determine transactional offers. In some cases, the transport plan engine may include a model built using artificial intelligence, such as using a machine learning algorithm (e.g., neural network) that may determine the timing and selection of transactional options. The transport plan engine and/or the recommendation engine can be components of the provided system. The terms “passenger commerce options” and “transactional options” are used interchangeably herein.

FIG. 5 shows another personalized transportation plan 500. In some cases, at least a portion of the travel is determined during the transportation. The transportation plan or travel plan may be updated in real-time based on one or more transactions the user has conducted during the trip or based on changes to the user's calendar. In some cases, the travel route and transportation plan may be displayed on a GUI to the user. The user may be permitted to interact with one or more of the graphical elements to, for example, accept or turn down a transactional offer/option, conduct a transaction, modify a stop or destination, modify a transportation mode, and various others.

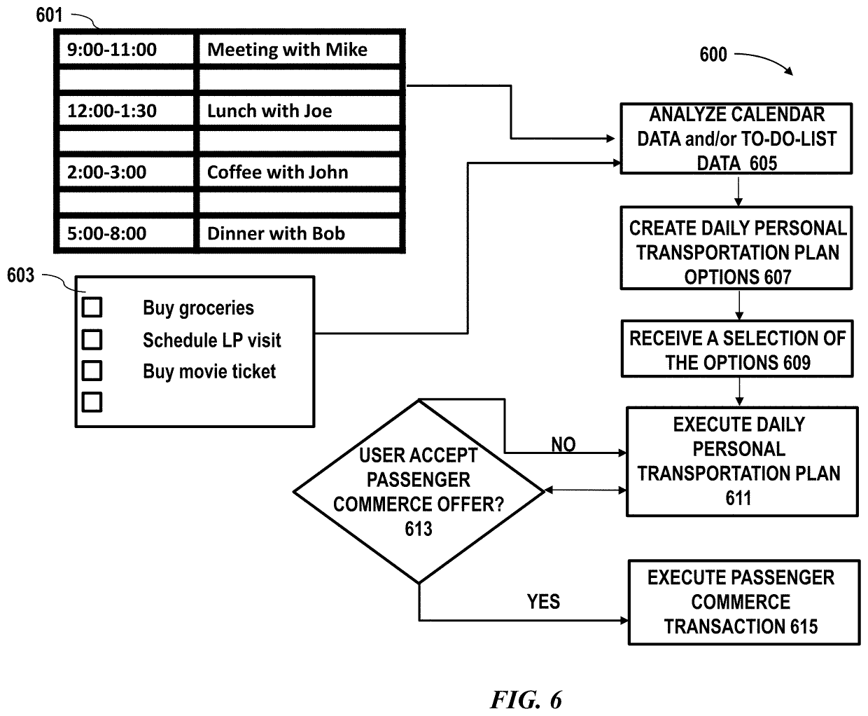

FIG. 6 shows an example process 600 of generating one or more transactional options for a user during a daily transportation. In the illustrated example, calendar data 601 and to-do list data 603 may be obtained and analyzed (operation 605). A daily personal transportation plan may be generated and may provide one or more options for a user to select (operation 607). The one or more options may include, for example, stops (e.g., restaurant for lunch with Joe, coffee shop for coffee with John, grocery store) during the trip, transactional options to be presented during the trip (e.g., purchase movie ticket), and transportation mode options for a segment (e.g., autonomous vehicle ride-hailing service from location to meet Mike to location to lunch with Joe, human-driven ride-hailing service from cafe shop to grocery store, etc). A user may make a selection of the one or more options via a GUI or other approaches (e.g., voice command or gesture) (operation 609). Alternatively or in addition to, a selection may be made by the system without user intervention. The personal transportation plan may be executed and one or more transactional options or passenger commerce offers may be displayed to the user (operation 611). For example, one or more transactional options may be delivered to the user in a visual manner (e.g., displayed on a user device, in-vehicle monitor, a built-in display on an e-Scooter or other vehicles, etc), in acoustic manner (e.g., interactive voice response (IVR) systems, smart speaker, etc) or a combination of both. A user may be prompted to accept or turn down a transaction option (operation 613). In some cases, if a user turns down a transactional offer, a new transactional option may be presented. In some cases, if a user accepts a transaction option, the user may be prompted to conduct and complete the passenger commerce transaction (operation 615).

Although FIG. 6 shows a method in accordance with some embodiments, a person of ordinary skill in the art will recognize that there are many adaptations for various embodiments. For example, the operations can be performed in any order. Some of the operations may be precluded, some of the operations may be performed concurrently in one step, some of the operations repeated, and some of the operations may comprise sub-steps of other operations. For instance, in some cases the transactional options are presented to a user sequentially and a user may not be presented a next transactional option until the previous one is conducted or rejected. In some cases, the timing for providing one or more passenger commerce options may be based on a current geolocation of the user and/or travel time. The method may also be modified in accordance with other aspects of the disclosure as provided herein.

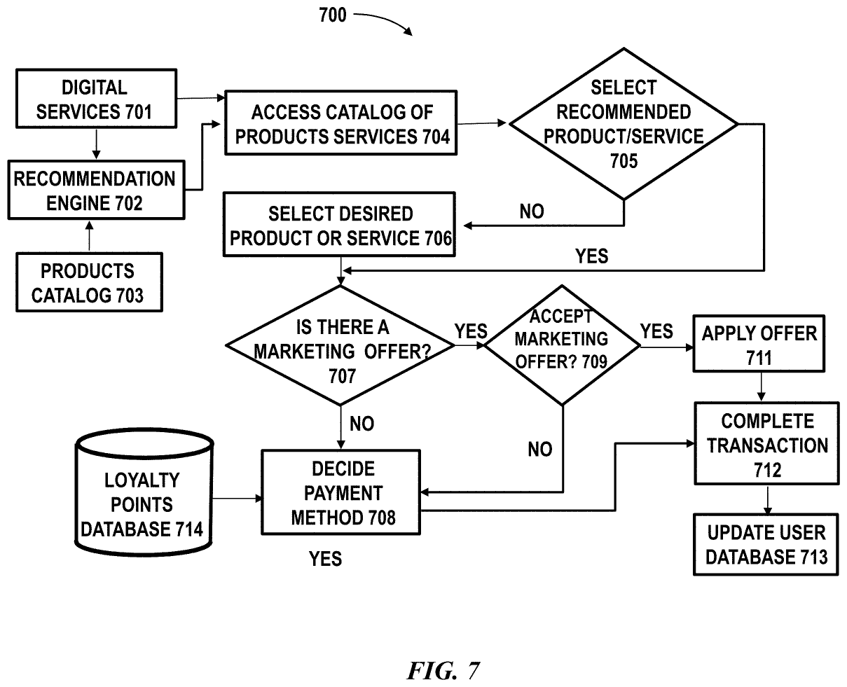

FIG. 7 shows an example process 700 of providing personalized passenger commerce during transportation. In some embodiments, the provided system may comprise a recommendation engine 702 configured to select one or more transactional options to offer to a user. Third-party services such as digital services 701 and products catalogs 703 are accessible by the recommendation engine. In some cases, upon receiving an instruction requesting a transactional offer, the recommendation engine may access catalog of products and services 704 and determine a recommended product or service 704. In some cases, the recommended product or service may be selected or determined based on user data. In some cases, if no recommended product or service can be determined, one or more candidate options may be presented to the user for selection. In such cases, a user may select a desired product or service 706. Alternatively or in addition to, a user may be permitted to enter a desired product or service manually. Upon determining a recommended or desired product/service, the system may look up for an available marketing offer 707. If an offer is available, a user may be prompted to accept or reject the offer 709. The offer may be applied to the transaction 711 if it is accepted by the user. In the case when the marketing offer is not accepted, a payment method may be decided 708 and loyalty information may be retrieved from loyalty points database 714 to calculate a final payment. The transaction may then be completed 712 and the user database may be updated 713 with the data related to the transaction. The transaction may be completed regardless the payment methods (e.g., credit card, virtual cash such as Uber Cash, etc). For example, a user may be prompted to choose a user preferred payment method on the user device or via an in-vehicle device.

In some embodiments, the recommendation engine may be a component of a transport plan engine or be coupled to a transport plan engine. The transport plan engine may be configured to generate a travel route with personalized passenger commerce offers provided to the user during transportation. In some cases, the transport plan engine may determine when and/or where to provide the passenger commerce offers. In some cases, the transport plan engine may generate an instruction to the recommendation engine to request a transactional option. In some cases, the timing and/or location to present a passenger commerce offer, or the selection of a passenger commerce offer may be automatically determined by a machine learning-based model of the transport plan engine.

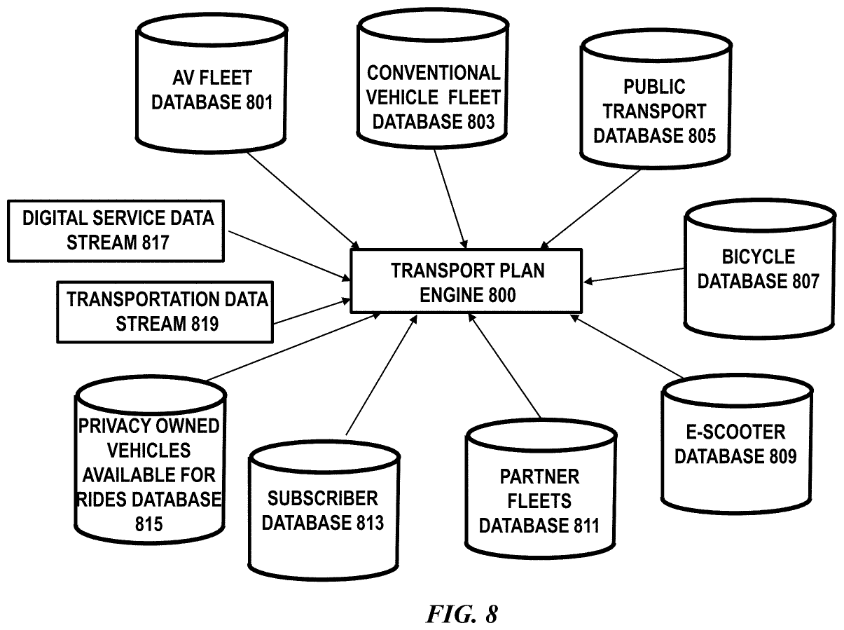

FIG. 8 schematically shows a transport plan engine 800 coupled to a plurality of databases and sources of data for generating a personalized transportation experience. As shown in FIG. 8, the transport plan engine 800 may be capable of accessing a plurality of databases or data sources such as an autonomous vehicle fleet database 801, a conventional vehicle fleet database 803, a public transport database 805, a bicycle database 807, a e-scooter database 809, a partner fleets database 811, a user (subscriber) database 813, a privacy owned vehicles available for rides database 815, as well as data streams such as digital service data stream 817 and transportation data stream 819. The transport plan engine 800 may retrieve data from one or more of the aforementioned databases and data sources to generate a travel route including stops or destinations, determine one or more transactional options to offer a user, determine timings/locations to represent a given transaction offer, and various others.

In some embodiments, a personalized transportation plan may be generated prior to starting a trip. In some embodiments, at least a portion of the personalized transportation plan may be generated during the transportation. For instance, a transportation plan may be generated in a step-by-step fashion. A step of a transportation plan may include a segment (e.g., transportation mode, schedule), a transactional option to offer to a user, a new destination or stop and various others. In some embodiments, at least a portion of the personalized transportation plan may be adjusted during the transportation.

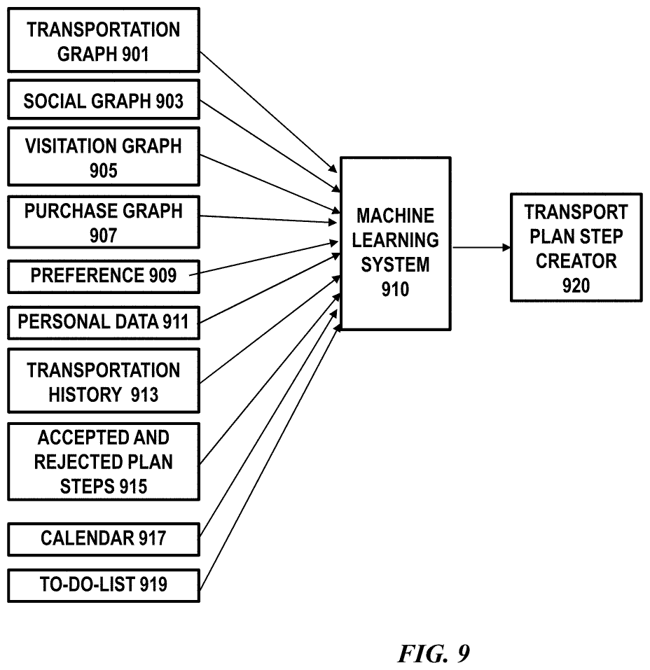

FIG. 9 shows a block diagram of a transport plan step creator 920. In some cases, the transport plan step creator may be a component of a transport plan engine as described elsewhere herein. In some cases, the transport plan step creator can be the same as the transport plan engine. In some embodiments, the transport plan step creator 920 may include a machine learning system 910. Input data supplied to the machine learning system 910 may comprise historical data such as transportation graph 901, social graph 903, visitation graph 905, user preference 909, personal data 911, transportation history 913, and previous accepted and rejected plan steps 915. The input data may also comprise calendar data 917 and 919. The output of the machine learning system 910 may be a step of a transportation plan. The step may include a segment (e.g., transportation mode, schedule), a transactional option to offer to a user, or a new destination or stop.

### Computer Systems

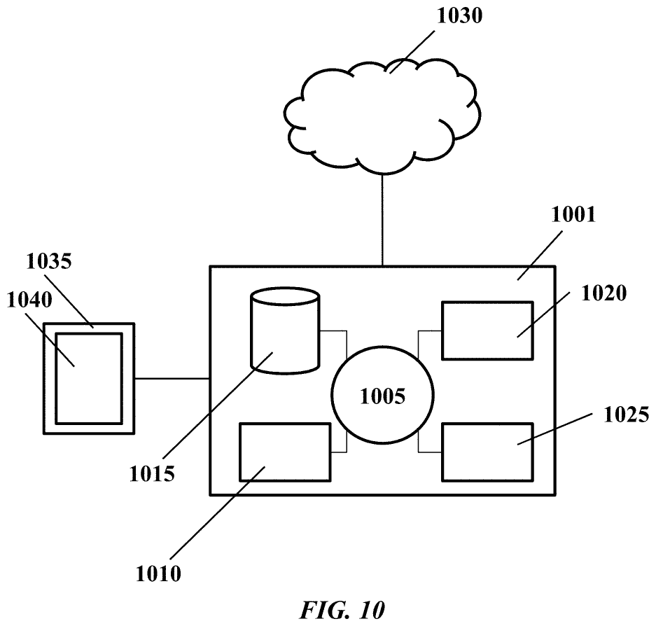

The personal transportation management system, transport plan engine, or processes described herein can be implemented by one or more processors. In some embodiments, the processor may be a processing unit of a computer system. FIG. 10 shows a computer system 1001 that is programmed or otherwise configured to implement the personal transportation management system. The computer system 1001 can regulate various aspects of the present disclosure. The computer system 1001 can be an electronic device of a user or a computer system that is remotely located with respect to the electronic device. The electronic device can be a mobile electronic device.

The computer system 1001 includes a central processing unit (CPU, also “processor” and “computer processor” herein) 1005, which can be a single core or multi core processor, or a plurality of processors for parallel processing. The computer system 1001 also includes memory or memory location 1010 (e.g., random-access memory, read-only memory, flash memory), electronic storage unit 1015 (e.g., hard disk), communication interface 1020 (e.g., network adapter) for communicating with one or more other systems, and peripheral devices 1025, such as cache, other memory, data storage and/or electronic display adapters. The memory 1010, storage unit 1015, interface 1020 and peripheral devices 1125 are in communication with the CPU 1005 through a communication bus (solid lines), such as a motherboard. The storage unit 1015 can be a data storage unit (or data repository) for storing data. The computer system 1001 can be operatively coupled to a computer network (“network”) 1030 with the aid of the communication interface 1020. The network 1030 can be the Internet, an internet and/or extranet, or an intranet and/or extranet that is in communication with the Internet. The network 1030 in some cases is a telecommunication and/or data network. The network 1030 can include one or more computer servers, which can enable distributed computing, such as cloud computing. The network 1030, in some cases with the aid of the computer system 1001, can implement a peer-to-peer network, which may enable devices coupled to the computer system 1001 to behave as a client or a server.

The CPU 1005 can execute a sequence of machine-readable instructions, which can be embodied in a program or software. The instructions may be stored in a memory location, such as the memory 1010. The instructions can be directed to the CPU 1005, which can subsequently program or otherwise configure the CPU 1005 to implement methods of the present disclosure. Examples of operations performed by the CPU 1005 can include fetch, decode, execute, and writeback.

The CPU 1005 can be part of a circuit, such as an integrated circuit. One or more other components of the system 1001 can be included in the circuit. In some cases, the circuit is an application specific integrated circuit (ASIC).

The storage unit 1015 can store files, such as drivers, libraries and saved programs. The storage unit 1015 can store user data, e.g., user preferences and user programs. The computer system 1001 in some cases can include one or more additional data storage units that are external to the computer system 1001, such as located on a remote server that is in communication with the computer system 1001 through an intranet or the Internet.

The computer system 1001 can communicate with one or more remote computer systems through the network 1030. For instance, the computer system 1001 can communicate with a remote computer system of a user (e.g., a user device). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), Smart watch, Smart speaker or personal digital assistants. The user can access the computer system 1001 via the network 1030.

Methods as described herein can be implemented by way of machine (e.g., computer processor) executable code stored on an electronic storage location of the computer system 1001, such as, for example, on the memory 1010 or electronic storage unit 1015. The machine executable or machine readable code can be provided in the form of software. During use, the code can be executed by the processor 1005. In some cases, the code can be retrieved from the storage unit 1015 and stored on the memory 1010 for ready access by the processor 1005. In some situations, the electronic storage unit 1015 can be precluded, and machine-executable instructions are stored on memory 1010.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 1001, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1001 can include or be in communication with an electronic display 1035 that comprises a user interface (UI) 1040 for providing, for example, a graphical user interface as described elsewhere herein. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1005. The algorithm can, for example, trained models such as transport plan engine.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for facilitating commerce while a user is traveling along a route, comprising:
(a) at a server, receiving a starting geographic location and a destination geographic location of said user;
(b) using said starting geographic location and said destination geographic location to generate said route for said user, which route is directed from said starting geographic location to said destination geographic location;
(c) using said server to extract contextual information associated with said destination geographic location; and
(d) using said server to identify one or more transactional options for said user along said route based at least in part on said contextual information.

2. The method of claim 1, further comprising, while said user is traveling in a terrestrial vehicle along at least a portion of said route, presenting said one or more transactional options to said user on an electronic device within said terrestrial vehicle.

3. The method of claim 1, wherein said one or more transactional options are determined based at least in part on one or more members selected from the group consisting of a social graph of said user, a transportation graph of said user, a visitation graph of said user, a purchase graph of said user, calendar data, and a to-do list data of said user.

4. The method of claim 1, wherein said contextual information comprises an activity associated with said destination geographic location.

5. The method of claim 1, wherein said one or more transactional options are determined based at least in part on a customer segment to which said user is assigned.

6. The method of claim 5, wherein said one or more transactional options are determined based at least in part on said customer segment to which said user is assigned.

7. The method of claim 1, wherein said user is assigned to multiple customer segments.

8. The method of claim 6, wherein said one or more transactional options are determined based at least in part on said multiple customer segments to which said user is assigned.

9. The method of claim 1, wherein said destination geographic location is automatically determined based at least in part on historical data related to said user.

10. The method of claim 1, wherein said destination geographic location is automatically determined using a machine learning algorithm trained model.

11. The method of claim 1, wherein said route and said one or more transactional options are generated using a machine learning algorithm.

12. The method of claim 1, further comprising determining a transportation mode for one or more portions of said route.

13. The method of claim 9, wherein said transportation mode comprises at least one of: (i) an autonomous vehicle, (ii) a human-driven automated vehicle, (iii) a ride-hailing service, (iv) a ride-sharing service, (v) rail transportation, and (vi) a terrestrial mass transit vehicle.

14. The method of claim 9, wherein a first transportation mode determined for a first portion of said route is different from a second transportation mode determined for a second portion of said route.

15. The method of claim 1, wherein at least one of said one or more transaction options is to be conducted at one or more locations connecting two or more segments of said route.

16. The method of claim 1, further comprising receiving a user input indicating acceptance of at least one of said one or more transaction options, and in response to receiving said user input, conducting said at least one of said one or more transaction options.

17. The method of claim 1, further comprising generating one or more new transaction options upon receiving a user input indicating a rejection of at least one of said one or more transaction options.

18. The method of claim 1, further comprising repeating at least one of (b) and (c) upon detecting a change in a calendar data or to-do-list data associated with said user.

19. A non-transitory computer-readable storage medium including instructions that, when executed by at least one processor of a computing system, cause the computing system to perform operations comprising:
(a) receiving a starting geographic location and a destination geographic location of said user;
(b) using said starting geographic location and said destination geographic location to generate said route for said user, which route is directed from said starting geographic location to said destination geographic location;
(c) extracting contextual information associated with said destination geographic location; and
(d) identifying one or more transactional options for said user along said route based at least in part on said contextual information.

20. The non-transitory computer-readable storage medium of claim 19, wherein said contextual information comprises an activity associated with said destination geographic location.
